(19) United States
(12) Patent Application Publication
(10) Pub. No.: US 2023/0245134 A1
(43) Pub. Date: Aug. 3, 2023

(54) SYSTEM AND METHOD FOR AUTOMATIC PRODUCT SOURCE TRACING

(71) Applicant: Walmart Apollo, LLC, Bentonville, AR (US)

(72) Inventors: Pratap Bhaskar, Bangalore (IN); Pranav Podutwar, Pune (IN); Manjesh KM, Ballari (IN); Chesla Kar, Bangalore (IN); Eli J. Steiger, Denver, CO (US); Bendi Vyshnavi, Vizianagaram (IN)

(21) Appl. No.: 17/591,464

(22) Filed: Feb. 2, 2022

(51) Int. Cl. G06Q 30/00; G06Q 50/26

(52) U.S. Cl. CPC G06Q 30/018; G06Q 50/265

(57) ABSTRACT

Method and system for automatic product source tracing are provided. A method for product source tracing comprises querying a supply chain distributed ledger and matching each case report to at least one product lot record in the supply chain distributed ledger based on the item descriptor, the case location identifier, and the case date recorded in the case report, assigning a weighting factor to each matched lot record matched with a case based on a completeness of the matched lot record, determining a supplier confidence score for a supplier based on the number of matched lot records associated with the supplier and weighting factors associated with each matched lot record associated with the supplier, and automatically generating a product safety tracing report comprising a ranked list of suppliers associated with the product safety issue based on supplier confidence scores of a plurality of suppliers.

### TECHNICAL FIELD

This invention relates generally to product source tracing and particularly to automatic product source tracing based on a distributed ledger.

### BACKGROUND

Food contamination and other product safety issues are public concerns that can also be costly to retailers. When the source of a product cannot be precisely identified, large-scale recalls are often required to ensure public safety. However, with the increasing scale and complexity of the global supply chain, tracing the source of a product is often difficult and slow.

### BRIEF DESCRIPTION OF THE DRAWINGS

Disclosed herein are embodiments of systems and methods for providing automatic product source tracing. This description includes drawings, wherein:

FIG. 1 comprises a block diagram of a system in accordance with some embodiments;

FIG. 2 comprises a flow diagram of a process in accordance with some embodiments;

FIG. 3 comprises a flow diagram of a process in accordance with some embodiments;

FIG. 4 comprises a flow diagram of a user process in accordance with some embodiments;

FIG. 5 comprises an example graphical user interface (GUI) in accordance with some embodiments;

FIG. 6 comprises an example GUI in accordance with some embodiments; and

FIG. 7 comprises an example of a report in accordance with some embodiments;

FIG. 8 comprises an illustration of blocks as configured in accordance with some embodiments;

FIG. 9 comprises an illustration of transactions configured in accordance with some embodiments;

FIG. 10 comprises a flow diagram in accordance with some embodiments;

FIG. 11 comprises a process diagram as configured in accordance with some embodiments;

FIG. 12 comprises an illustration of a delivery record configured in accordance with some embodiments; and

FIG. 13 comprises a system diagram configured in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices, and methods are provided for automatic product source tracing. A system for product source tracing comprises a network interface configured to communicate with a plurality of nodes of a supply chain distributed ledger corresponding to a plurality of entities in a supply chain, a user interface device, and a control circuit coupled to the network interface and the user interface device. The control circuit being configured to communicate, via the network interface, with the plurality of nodes of the supply chain distributed ledger as a node of the supply chain distributed ledger. The supply chain distributed ledger comprises a plurality of product lot records associated with a plurality of products, wherein each product lot record comprises a series of supply chain events, and each supply chain event is associated with a supply chain entity and a date. The control circuit is further configured to receive a product source query comprising an item descriptor and a plurality of case records, wherein each case record comprises a case location identifier and a case date associated with a product safety issue, and query the supply chain distributed ledger and match each case report to at least one product lot record in the supply chain distributed ledger based on the item descriptor, the case location identifier, and the case date recorded in the case report. The control circuit then assigns a weighting factor to each matched lot record matched with a case in the product source query based on a completeness of the matched lot record, determine a supplier confidence score for a supplier based on the number of matched lot records associated with the supplier and weighting factors associated with each matched lot record associated with the supplier, and automatically generates a product safety tracing report for display via the user interface device, the product safety tracing report comprises a ranked list of suppliers associated with the product safety issue based on supplier confidence scores of a plurality of suppliers.

When a retail product safety issue (e.g. food contamination, outbreak), there is generally an investigation carried out by a regulator and/or retailers to identify the supplier and origination of the products. In some embodiments, a product investigation tool is developed to investigate and identify the probabilistic match (Confidence Factor) for the suppliers and lots for each supplier responsible for the products in an investigation. Food safety source tracing can be used to minimize the scope of recalls, which cost retailers upwards of millions of dollars. With increased data compliance from suppliers, regulators (e.g. Food and Drug Administration and Center of Disease Control) have also begun to request assistance with food safety investigations from retailers.

In some embodiments, supply chain data from multiple parties are organized into standardized data fields using GS1 Electronic Product Code Information Service (EPCIS) events. The system may start with unknown purchase orders, items, global trade item numbers (GTINs), lot numbers, and supplier information. In some embodiments, the process may start with only a product or ingredient description, locations, and a date range. In some embodiments, the system does not rely on a single enterprise resource planning (ERP) software for the entire supply chain. In some embodiments, the system is configured to output confidence factors associated with traced sources using blockchain trace data. In some embodiments, the system may be configured to provide a report on any number of possible supply chain events associated with an incident, including events associated with farms, processing facilities, distribution centers (DCs), and stores. In some embodiments, the system automatically formats the report into a regulatory agency (e.g. FDA) preferred format.

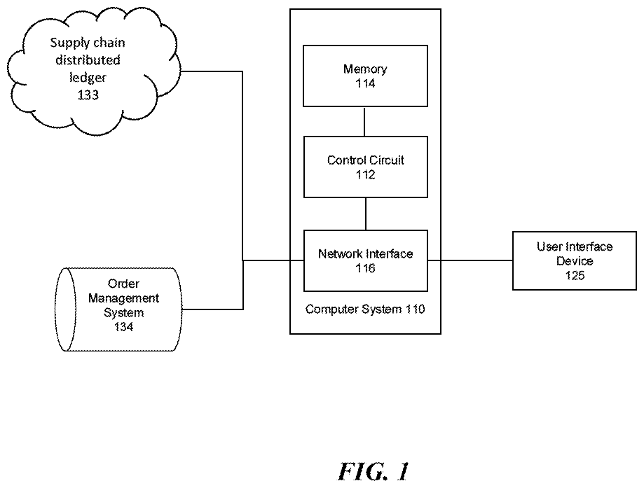

Referring now to FIG. 1, a system for automatic product source tracing is shown. The computer system 110 is coupled to a supply chain distributed ledger 133, an order management system 134, and a user interface device 125.

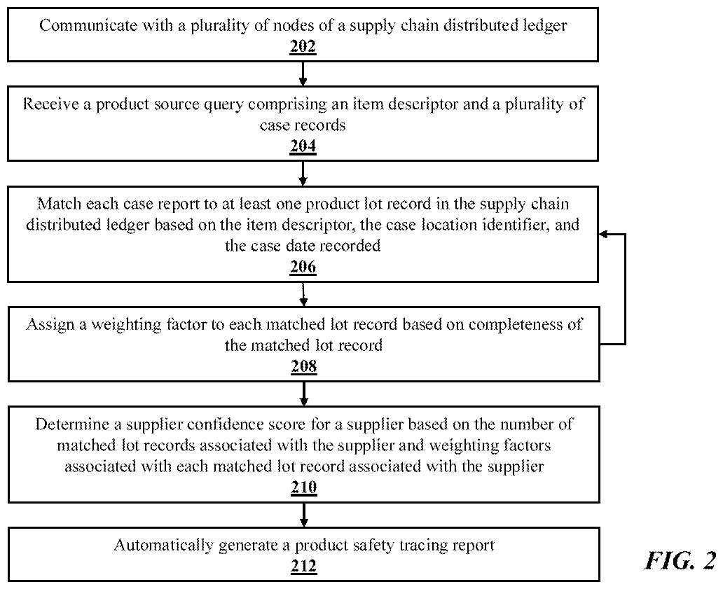

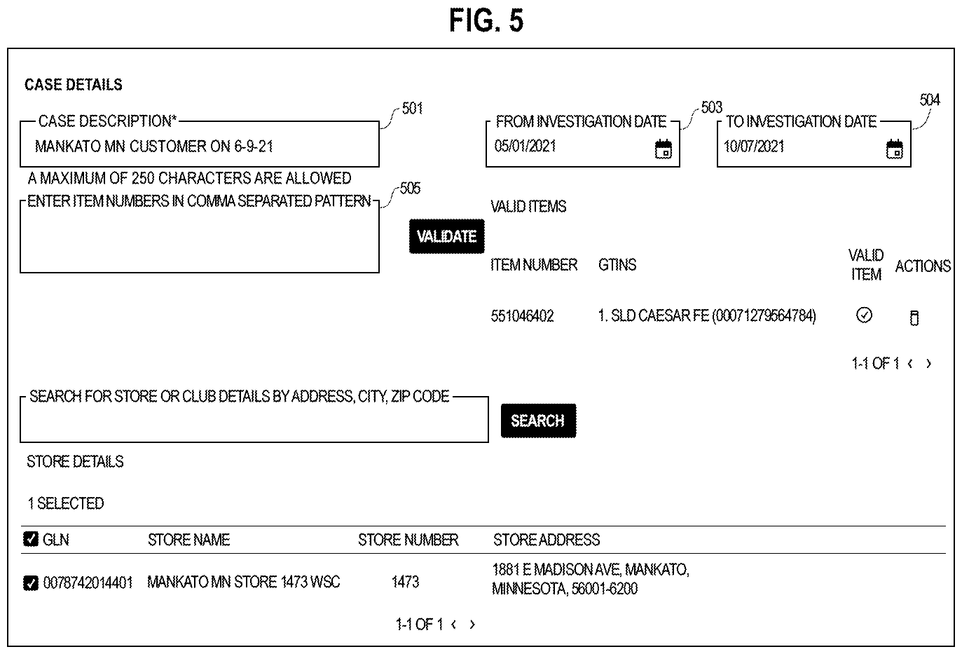

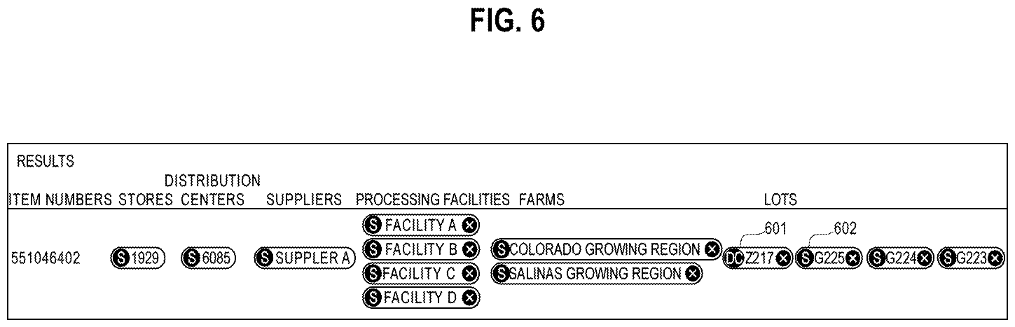

The computer system 110 comprises a control circuit 112, a memory 114, and a network interface device 116. The computer system 110 may comprise one or more of a server, a retailer backend system, a central computing system, a desktop computer system, and the like. The control circuit 112 may comprise a processor, a microprocessor, a central processing unit (CPU), a graphics processing unit (GPU), an application-specific integrated circuit (ASIC), and the like and may be configured to execute computer-readable instructions stored on a computer-readable storage memory 114. The computer-readable storage memory 114 may comprise volatile and/or non-volatile memory and have stored upon it, a set of computer-readable instructions which, when executed by the control circuit 112, causes the computer system 110 to generate product source tracing reports based on information received via the user interface device and data stored in the supply chain distributed ledger 133 and the order management system 134. In some embodiments, the control circuit 112 may execute a program to function as a node of the supply chain distributed ledger 133 that verifies and updates the supply chain distributed ledger 133 collectively with one or more other nodes. In some embodiments, the computer-executable instructions may cause the control circuit 112 of the computer system 110 to perform one or more steps described with reference to FIGS. 2-4. In some embodiments, the computer-executable instructions may cause the control circuit 112 of the computer system 110 to provide a user interface for viewing and interacting with the source tracing tool, such as the GUIs described with reference to FIGS. 5-6. In some embodiments, the memory 114 may further store at least a portion of the supply chain distributed ledger 133.

The network interface device 116 may comprise a data port, a wired or wireless network adapter, and the like. In some embodiments, the computer system 110 may communicate with the user interface device 125 and/or other nodes of the supply chain distributed ledger over a network such as a local network, a private network, or the Internet. In some embodiments, the user interface device 125 may be a processor-based standalone user device with a storage memory device, such as a personal computer, a desktop computer, a laptop computer, a mobile device, a smartphone, and the like. The user interface device 125 may comprise user input/output devices such as a keyboard, a mouse, a touch screen, a display screen, a VR/AR display device, a speaker, a microphone, etc. The user interface device 125 may execute an application for accessing a GUI for interacting with the product source tracing tool provided by the computer system 110. For example, the user interface device 125 may comprise a mobile phone running an application or a computer accessing a network site. A user may use the user interface device 125 to enter or upload product tracing queries, change one or more parameters of a query, and view the generated report.

The supply chain distributed ledger 133 comprises a distributed database comprising a plurality of nodes. In some embodiments, the supply chain distributed ledger comprises a plurality of product lot records associated with a plurality of products. In some embodiments, each product lot record comprises a series of supply chain events, and each supply chain event is associated with a supply chain entity and a date. In some embodiments, a supply chain event may include an entities identifier (e.g. farm region, processor name and location, supplier name and location, distribution identifier, and store identifier) and a date that the lot is transferred to or from the entity. For example, a product lot record may include the date that the lot is shipped out by a lot supplier and the date a distribution center receives the shipment. In some embodiments, each product lot record is associated with a lot number that is an identification number assigned to a certain quantity or groups of products from a single manufacturer, supplier, processor, or farm. Generally, products in a lot are kept together in the supply chain until they reach a retail location or an order fulfillment center. In some embodiments, the distributed ledger may comprise a cryptographically verifiable ledger managed by a peer-to-peer network. In some embodiments, the supply chain distributed ledger 133 may comprise a blockchain database collectively verified and updated by computer systems associated with any number of entities in the supply chain functioning as nodes of the blockchain. For example, the blockchain may be updated and/or verified by retail stores, transporters, warehouses, distribution centers, suppliers, processors, manufacturers, farms, etc. In some embodiments, entities of the supply chain may update product lot records with supply chain events associated with the entity and sign the update with its cryptographically verifiable signature. In some embodiments, the updates of the supply chain events may be automatically triggered at one or more computer systems by fulfillment of conditions in a smart contract and/or based on departure or arrival scans of products by a scanning device such as a camera, an optical code (e.g. barcode, QR code) reader, a radio frequency identification tag reader, etc. Other entities may collectively verify the update requests before each update becomes a permeant part of the blockchain record. Further details of a blockchain that may be used with the systems and methods described herein are described with reference to FIGS. 9-13.

The order management system 134 may comprise one or more processor-based devices that receive, process, forward, and/or record purchase orders and inventory information. In some embodiments, the order management system 134 is configured to communicate with a plurality of suppliers, distribution centers, and local retail stores to manage and coordinate shipments to and from distribution centers, store locations, and order fulfillment centers. In some embodiments, the information recorded in the order management system 134 may comprise an order database that records arrival events at distribution centers and/or store locations. In some embodiments, the arrival scans may be added to the product logistic record in the supply chain distributed ledger 133. In some embodiments, the information recorded in the order management system 134 may be used to supplement the supply chain data available from the supply chain distributed ledger for source tracing and/or be used to determine lot record completeness. In some embodiments, the order management system 134 may comprise a product database comprising a computer-readable memory storage storing product information associated with products for sale. In some embodiments, the product information may comprise product characteristics such as product category, product sub-category, product price, product age restriction, product nutrition label information, product description, etc. associated with the product identifier. In some embodiments, the computer system 110 may further use the product database to match an item description in a product tracing query to one or more item numbers (e.g. GTIN, UPC).

While one computer system 110 is shown, in some embodiments, the functionalities of the computer system 110 may be implemented on a plurality of processor devices communicating on a network. In some embodiments, the computer system 110 may be coupled to a plurality of user interface devices 125 and simultaneously respond to any number of product trace queries from one or more user interface devices 125.

Referring now to FIG. 2, a method for automatic product source tracing is shown. In some embodiments, the steps shown in FIG. 2 may be performed by a processor-based device such as a control circuit executing a set of computer-readable instructions stored on a computer-readable memory. In some embodiments, one or more steps of FIG. 2 may be performed by the computer system 110 described with reference to FIG. for a similar device.

In step 202, the system communicates with the plurality of nodes of the supply chain distributed ledger as a node of the supply chain distributed ledger. In some embodiments, the supply chain distributed ledger may be the supply chain distributed ledger 133 described with reference to FIG. 1 herein. In some embodiments, the supply chain distributed ledger comprises a plurality of product lot records associated with a plurality of products, wherein each product lot record comprises a series of supply chain events, and each supply chain event is associated with a supply chain entity and a date. In some embodiments, a product lot record comprises at least a first supply chain event associated with a lot supplier and a second supply chain event associated with a distribution center. In some embodiments, each supply chain event in a product lot record is updated by a supply chain entity associated with the supply chain event. In some embodiments, the supply chain distributed ledger may comprise a blockchain and the system may comprise a node of the blockchain as described with reference to FIGS. 9-13 herein. In some embodiments, the communications may include ledger updates, verifications, and/or ledger queries.

In step 204, the system receives a product source query comprising an item descriptor and a plurality of case records. In some embodiments, each case record comprises a case location identifier and a case date range associated with a product safety issue. In some embodiments, the cases may originate from a regulatory agency (e.g. FDA, CDC) and/or be based on customer reports. In some embodiments, the item descriptor may comprise a product name, product category, product description, and/or product unique identifier (e.g. GTIN, UPC). In some embodiments, the location identifier may comprise a geographic region (e.g. city, zip code, neighborhood) and/or a specific store location or retail channel (e.g. home delivery).

In step 206, the system queries the supply chain distributed ledger and matches each case report to at least one product lot record in the supply chain distributed ledger based on the item descriptor, the case location identifier, and the case date recorded in the case report. In some embodiments, the system may first query an order management system to determine the lot numbers that are associated with the location and time of each case report and use the lot numbers to query the distributed ledger. For example, a location identifier (e.g. zip code) may include five different store locations, and the order management system may be used to determine whether products matching the product identifier were in stock and offered for sale in each of the store locations to filter out store locations down to three. Lot numbers of lots received at these stores just prior to or during the entered date range may then be used as the possible lot number with store traces. The system may further query distribution shipment records to lot numbers of lots shipped to a particular region and/or store just prior to or during the date range, even if the arrival of the lot is not recorded at any of the store locations. The system retrieves supply chain event records associated with each lot that may be associated with the product safety issue from the distributed ledger.

In step 208, each matched lot record is assigned a weighting factor based on the completeness of the matched lot record. In some embodiments, the completeness of a matched lot record is determined based on a supply chain entity associated with a last supply chain event in the matched lot record. For example, a lot record with store receiving information (e.g. receipt confirmation, time, and date) may be assigned a higher weighting factor compared to a lot record without store receiving information. In some embodiment, lot transfer information stored in an order management system 134 may be used to supplement the data recorded in the supply chain distributed ledger to form the lot record and/or be used to determine lot record completeness. Steps 208 and 208 may be repeated until all case reports are matched with at least one lot number and each lot number is assigned a weighting factor.

In step 210, the system automatically determines a supplier confidence score for a supplier based on the number of matched lot records associated with the supplier and weighting factors associated with each matched lot record associated with the supplier. In some embodiments, the supplier confidence is an indicator of how likely the particular supplier supplied the items that caused the product safety issue. In some embodiments, the supplier confidence score is further determined based on dividing a supplier weightage of all case records associated with the product safety issue by a sum of a total weightage for all suppliers associated with product lot records matched to cases associated with the product safety issue. In some embodiments, a supplier weightage for a case record is determined based on adding a first value calculated based on multiplying the number of matched product lot records associated with the supplier having an incomplete record with a first weightage and a second value calculated based on multiplying the number of matched product lot records associated with the supplier having a complete record with a second weightage greater than the first weightage. In some embodiments, the supplier weightage for each case record is further determined based on adding a third value calculated based on multiplying a case weightage with a trace weightage, wherein the trace weightage is less than one if a least one matched lot record is associated with the supplier for the case is incomplete. In some embodiments, the total weightage for all suppliers associated with the product lot records matched to the cases associated with the product safety issue is determined based on adding the number of case records multiplied by a case weightage and a count of supplier occurrences in all cases multiplied by a supplier weightage. In some embodiments, the supplier confidence score is further determined based on a supplier volume weighting factor associated with a percentage of total store location inventory provided by the supplier. In some embodiments, the system is further configured to determine a lot confidence score for a product lot based on the number of matched lot records associated with cases of the product safety issue and weighting factors associated with each matched lot record associated with the cases. In some embodiments, the system is further configured to similarly determine confidence scores for other entities of the supply chain such as processors, farms, farm regions, transportation providers, etc. based on the same calculation. In some embodiments, after step 210, if the confidence level of a supplier, processor, farm, lot, etc. exceeds a predetermined threshold a recall process may be automatically triggered to generate notifications to stores to pull the identified products from the shelves and notify customers of the recall.

As an example, the description below illustrates the calculation of supplier and lot confidence factors based on product lot records having two degrees of completeness. A store trace or store scan records refer to lot records including retail store arrival information (e.g. receipt confirmation, arrival time). A distribution center (DC) trace or DC scan refers to lot records without retail store arrival information and the last update in the lot record came from a DC. In this example, the ratio of result derived from STORE_TRACE: DC_TRACE is taken as 1:0.75, and the ratio of case weightage to supplier weightage is taken as 10:1.

The confidence factor of a supplier can be calculated by: (Supplier weightage in all the cases*100)/(Sum of the total weightages for all the suppliers)

A supplier weightage in a case can be calculated as: Case weightage*(TRACE_WEIGHTAGE)+(Number of times supplier appeared in the case as STORE_TRACE*1*Supplier weightage)+(Number of times supplier appeared in the case as DC_TRACE)*0.75*Supplier weightage)

If there is a single occurrence of supplier with demarcation as STORE_TRACE in a case, the trace weightage is equal to 1 else 0.75

Sum of the total weights of all the suppliers can be calculated as: (Number of cases*Case Weightage)+(Count of supplier occurrences in all the cases*Supplier Weightage)

The confidence factor of a LOT for a supplier can be calculated by: (Lot weightage for Supplier in all the cases*100)/(Sum of the total weights of all the lots for a supplier in all the cases)

The weightage of a lot for a supplier in a single case can be calculated by Case weightage*(TRACE_WEIGHTAGE)+(Number of times lot for supplier appeared in the case as STORE_TRACE*1*Lot Per Supplier weightage)+(Number of times the lot for supplier appeared in the case as DC_TRACE)*0.75*Lot Per Supplier weightage)

If there is a single occurrence of a lot for supplier with demarcation as STORE_TRACE in a case, the trace weightage is equal to 1 else 0.75.

The Sum of the total weights of all the lots for a supplier in all the cases can be calculated by: (Number of cases the supplier is present*10)+(Count of all the lots for the supplier in all the cases*1)

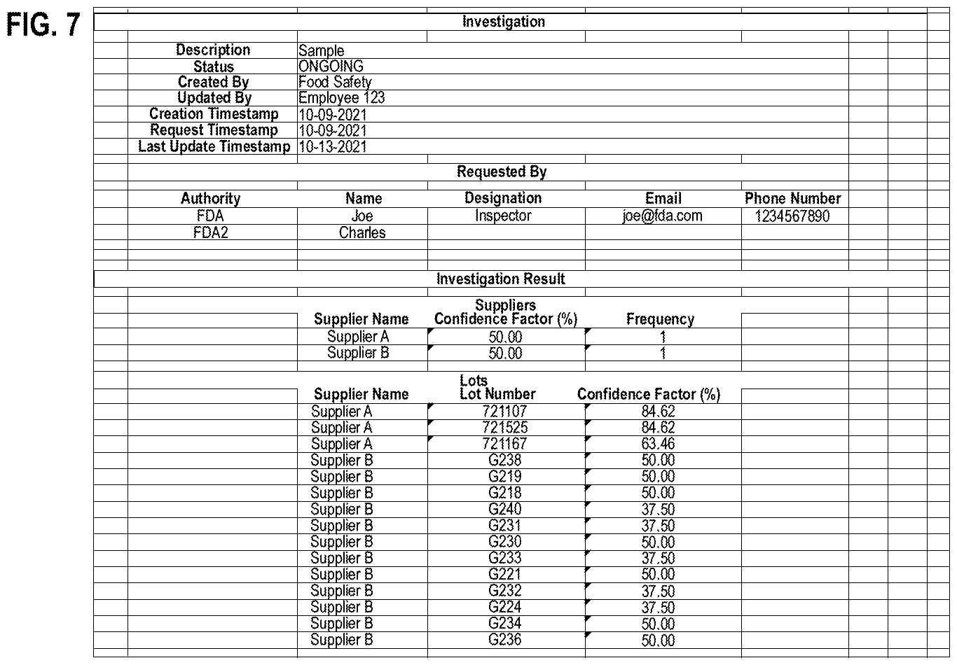

In step 212, the system automatically generates a product safety report. In some embodiments, the product safety tracing report comprises a ranked list of suppliers associated with the product safety issue based on supplier confidence scores of a plurality of suppliers. In some embodiments, the product safety tracing report further comprises a ranked list of lots associated with the product safety issue based on lot confidence scores for a plurality of lots. In some embodiments, the report may be automatically formatted in a regulatory agency preferred format. An example of a product safety report is described herein with reference to FIG. 7 herein.

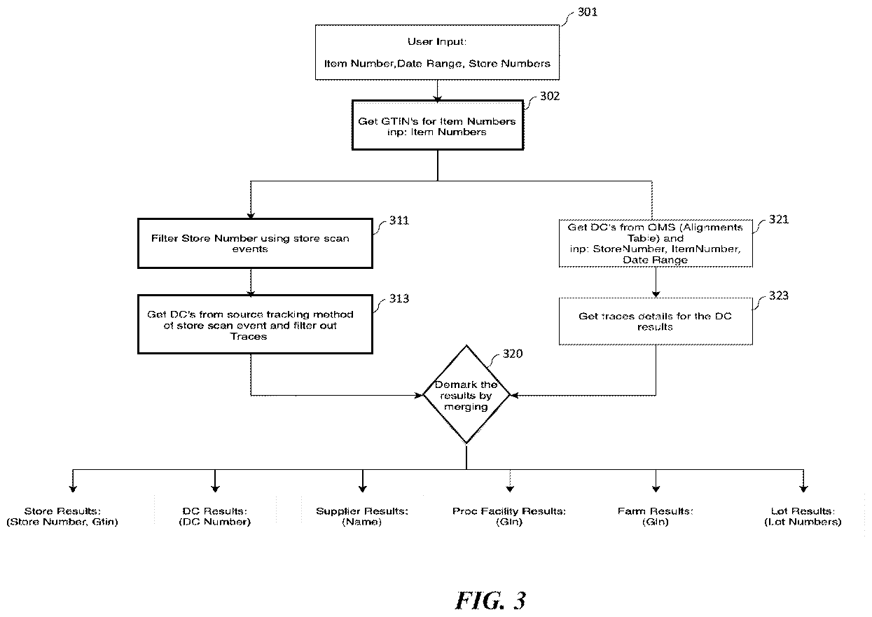

Referring now to FIG. 3, a method for automatic product source tracing is shown. In some embodiments, the steps shown in FIG. 3 may be performed by a processor-based device such as a control circuit executing a set of computer-readable instructions stored on a computer-readable memory. In some embodiments, one or more steps of FIG. 3 may be performed by the computer system 110 described with reference to FIG. 1 or a similar device.

In step 301, the system receives input for a product source query, including an item number, a date range, and one or more store numbers. In some embodiments, the query may be uploaded to the system in a spreadsheet data file including data on a plurality of case records. In step 302, the GTINs are retrieved based on the item numbers. In step 311, the system filters the store numbers received in step 301 based on store scan events. In step 313, the system determines the associated distribution centers from the source tracing method of store scan events and filter out the traces. In step 321, the system uses the store number, the item number, and the date range to determine associated distribution centers from an alignment table stored at the order management system. in step 323, trace details are determined based on the distribution results from step 321. In step 320, the system demarks the lot traces from steps 313 and 323 by merging. The supply chain trace data may then be used to trace the supply chain upstream based on data stored in the supply chain distributed ledger, and output a list of possible stores, distribution centers, suppliers, processing facilities, frames, and lots that may be associated with the product safety issue

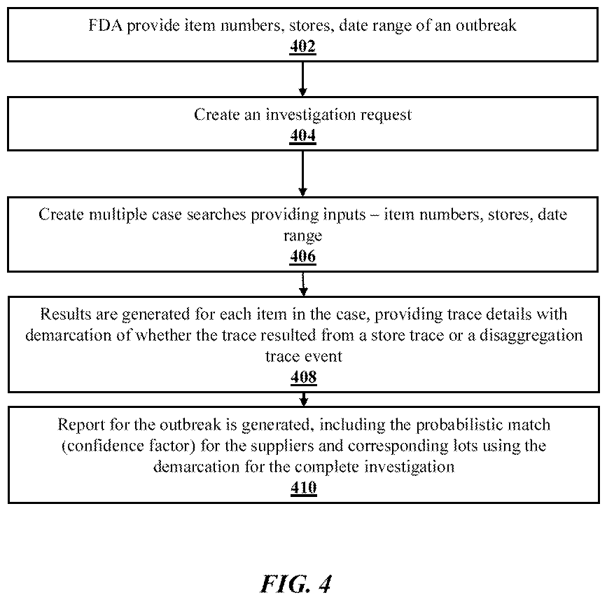

Referring now to FIG. 4, a method for automatic product source tracing is shown. In some embodiments, the steps shown in FIG. 4 may be performed by a processor-based device such as a control circuit executing a set of computer-readable instructions stored on a computer-readable memory. In some embodiments, one or more steps of FIG. 4 may be performed by the computer system 110 described with reference to FIG. 1 or a similar device.

In step 402, a regulatory agency (e.g. FDA) provides item numbers, stores, and date ranges of a product safety issue such as a food born illness outbreak. In step 404, an investigation request is created in the system. In step 406, the user creates multiple case searches by providing item numbers, stores, and date ranges. An example GUI for creating case searches is shown in FIG. 5. To create a case search, a user may enter and validate item numbers in field 501, search and add store locations based on address, city, and/or zip code in field 505, and enter an investigation date range in fields 503 and 504.

In step 408 results are generated for each item in the case, providing trace details with the demarcation of whether the trace resulted from a store trace or a disaggregation trace event. An example GUI for case search results is shown in FIG. 6, potential stores, distribution centers, suppliers, processing facilities, farms, and lots that match the search parameters entered in step 406 are displayed. In some embodiments, the lot numbers may include an indicator showing the completeness of the record, e.g. store scan recorded 602 or a distribution center scan available 601.

In step 410, a report for the outbreak is generated, including the probabilistic match (confidence factor) for the suppliers and corresponding lots using the demarcation for the complete investigation. FIG. 7 shows an example report. In the report, possible suppliers (supplier A and supplier B) are listed along with their respective confidence factors and case occurrence frequency. Possible lot identifiers (e.g. 721107, 721525, G238, G219, etc.) associated with the product safety issue are also listed with their respective confidence factors. While only two suppliers are shown, the report can include any number of suppliers and/or lot identifiers identified through the process described herein. In some embodiments, the report may further provide a listing of other entities in the supply chain, such as processors, farms, transportation providers, etc.

Descriptions of some embodiments of blockchain technology are provided with reference to FIG. 9-13 herein. In some embodiments of the invention described above, blockchain technology may be utilized to record supply chain events and supply information for product source tracing. One or more of the systems associated with supply chain entities described herein may comprise a node in a distributed blockchain system storing a copy of the blockchain record. Updates to the blockchain may comprise supply chain events such as transfer of items from one supply chain entity to another and/or the processing of a product from one form to another (e.g. cases of tomato to salad kit) and one or more nodes on the system may be configured to incorporate one or more updates into blocks to add to the distributed database.

Distributed databases and shared ledger databases generally refer to databases based on peer-to-peer record-keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

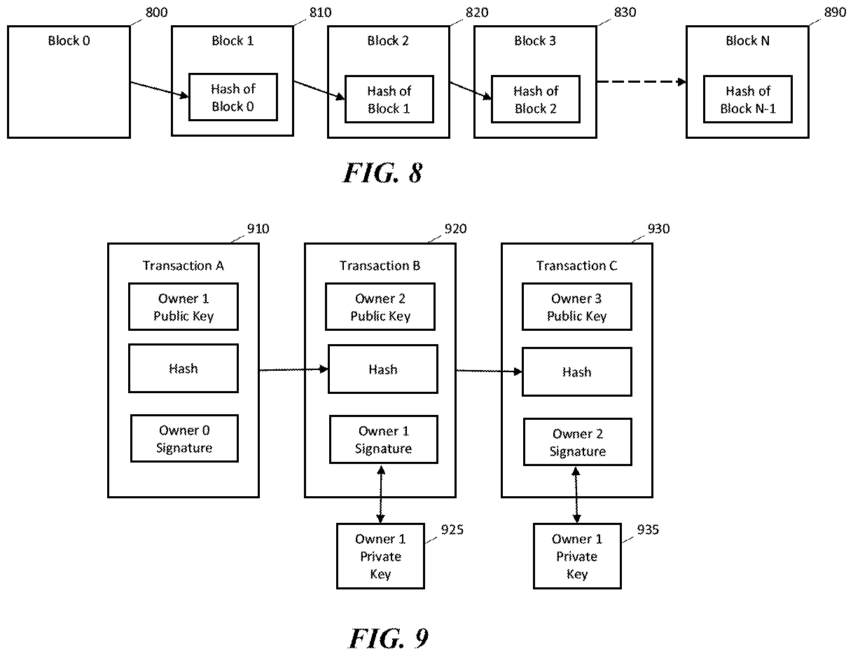

Now referring to FIG. 8, an illustration of a blockchain according to some embodiments is shown. In some embodiments, a blockchain comprises a hash chain or a hash tree in which each block added in the chain contains a hash of the previous block. In FIG. 8, block 0 800 represents a genesis block of the chain. Block 1 810 contains a hash of block 0 800, block 2 820 contains a hash of block 1 810, block 3 830 contains a hash of block 2 820, and so forth. Continuing down the chain, block N 890 contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

Now referring to FIG. 9, an illustration of blockchain-based transactions according to some embodiments is shown. In some embodiments, the blockchain illustrated in FIG. 9 comprises a hash chain protected by private/public key encryption. Transaction A 910 represents a transaction recorded in a block of a blockchain showing that owner 1 (recipient) obtained an asset from owner 0 (sender). Transaction A 910 contains owner's 1 public key and owner 0's signature for the transaction and a hash of a previous block. When owner 1 transfers the asset to owner 2, a block containing transaction B 920 is formed. The record of transaction B 920 comprises the public key of owner 2 (recipient), a hash of the previous block, and owner 1's signature for the transaction that is signed with the owner 1's private key 925 and verified using owner 1's public key in transaction A 910. When owner 2 transfers the asset to owner 3, a block containing transaction C 930 is formed. The record of transaction C 930 comprises the public key of owner 3 (recipient), a hash of the previous block, and owner 2's signature for the transaction that is signed by owner 2's private key 935 and verified using owner 2's public key from transaction B 920. In some embodiments, when each transaction record is created, the system may check previous transaction records and the current owner's private and public key signature to determine whether the transaction is valid. In some embodiments, transactions may be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double-spending the asset. The transactions in FIG. 9 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

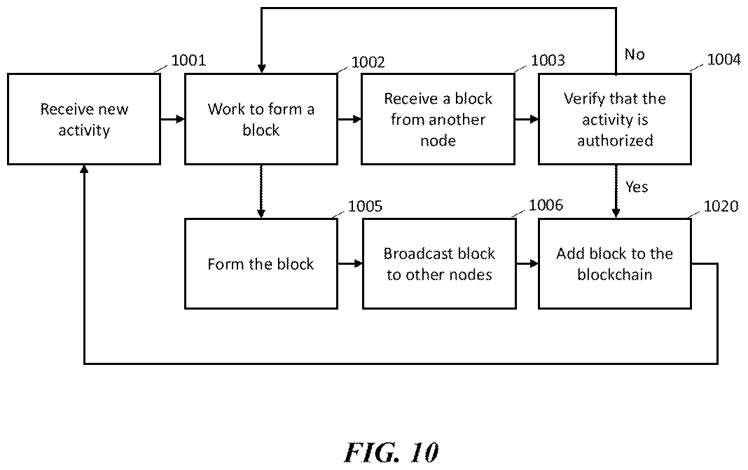

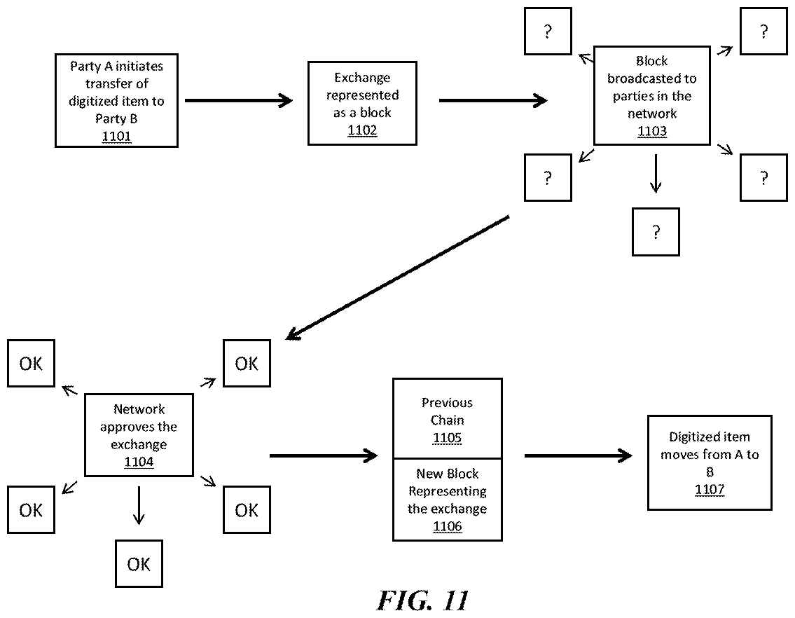

Now referring to FIG. 10, a flow diagram according to some embodiments is shown. In some embodiments, the steps shown in FIG. 10 may be performed by a processor-based device, such as a computer system, a server, a distributed server, a timestamp server, a blockchain node, and the like. In some embodiments, the steps in FIG. 10 may be performed by one or more of the nodes in a system using blockchain for record-keeping.

In step 1001, a node receives a new activity. The new activity may comprise an update to the record being kept in the form of a blockchain. In some embodiments, for blockchain-supported digital or physical asset record-keeping, the new activity may comprise an asset transaction. In some embodiments, the new activity may be broadcasted to a plurality of nodes on the network prior to step 1001. In step 1002, the node works to form a block to update the blockchain. In some embodiments, a block may comprise a plurality of activities or updates and a hash of one or more previous blocks in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem to form a nonce in order to form a block. In some embodiments, the node may be configured to verify that the activity is authorized prior to working to form the block. In some embodiments, whether the activity is authorized may be determined based on records in the earlier blocks of the blockchain itself

After step 1002, if the node successfully forms a block in step 1005 prior to receiving a block from another node, the node broadcasts the block to other nodes over the network in step 1006. In some embodiments, in a system with incentive features, the first node to form a block may be permitted to add incentive payment to itself in the newly formed block. In step 1020, the node then adds the block to its copy of the blockchain. In the event that the node receives a block formed by another node in step 1003 prior to being able to form the block, the node works to verify that the activity recorded in the received block is authorized in step 1004. In some embodiments, the node may further check the new block against system consensus rules for blocks and activities to verify whether the block is properly formed. If the new block is not authorized, the node may reject the block update and return to step 1002 to continue to work to form the block. If the new block is verified by the node, the node may express its approval by adding the received block to its copy of the blockchain in step 1020. After a block is added, the node then returns to step 1001 to form the next block using the newly extended blockchain for the hash in the new block.

In some embodiments, in the event one or more blocks having the same block number is received after step 1020, the node may verify the later arriving blocks and temporarily store these blocks if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 1001.

Now referring to FIG. 11, a process diagram a blockchain update according to some implementations is shown. In step 1101, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 1102, the exchange initiated in step 1101 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide proof of work for a block may earn a Bitcoin. In some embodiments, a block may comprise one or more transactions between different parties that are broadcasted to the nodes. In step 1103, the block is broadcasted to parties in the network. In step 1104, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 1106 representing the exchange is added to the existing chain 1105 comprising blocks that chronologically precede the new block 1106. The new block 1106 may contain the transaction(s) and a hash of one or more blocks in the existing chain 1105. In some embodiments, each node may then update their copy of the blockchain with the new block and continue to work on extending the chain with additional transactions. In step 1107, when the chain is updated with the new block, the digitized item is moved from party A to party B.

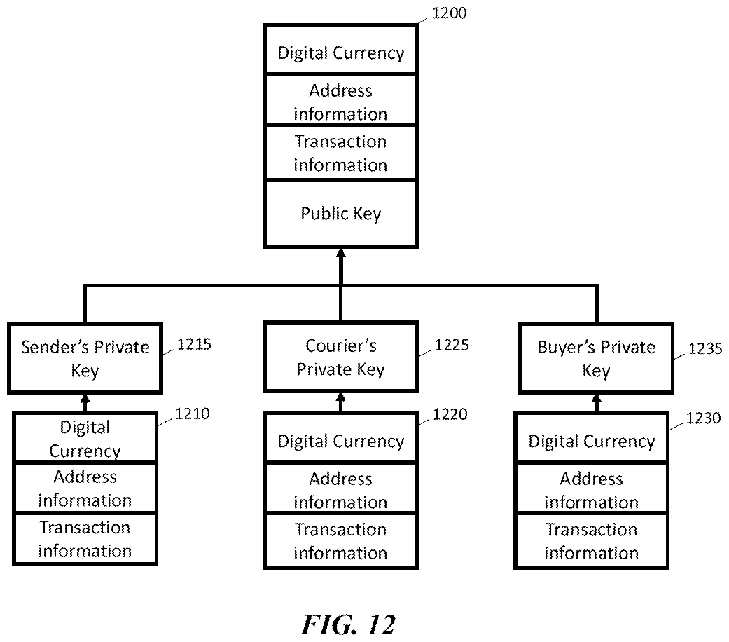

Now referring to FIG. 12, a diagram of a blockchain according to some embodiments in shown. FIG. 12 comprises an example of an implementation of a blockchain system for delivery service record keeping. The delivery record 1200 comprises digital currency information, address information, transaction information, and a public key associated with one or more of a sender, a courier, and a buyer. In some embodiments, nodes associated with the sender, the courier, and the buyer may each store a copy of the delivery record 1210, 1220, and 1230 respectively. In some embodiments, the delivery record 1200 comprises a public key that allows the sender, the courier, and/or the buyer to view and/or update the delivery record 1200 using their private keys 1215, 1225, and 1235 respectively. For example, when a package is transferred from a sender to the courier, the sender may use the sender's private key 1215 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 1225 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 12, the delivery record may be updated by one or more of the sender, courier, and the buyer to form a record of the transaction without a trusted third party while preventing unauthorized modifications to the record. In some embodiments, the blockchain-based transactions may further function to include transfers of digital currency with the completion of the transfer of physical assets. With the distributed database and peer-to-peer verification of a blockchain system, the sender, the courier, and the buyer can each have confidence in the authenticity and accuracy of the delivery record stored in the form of a blockchain.

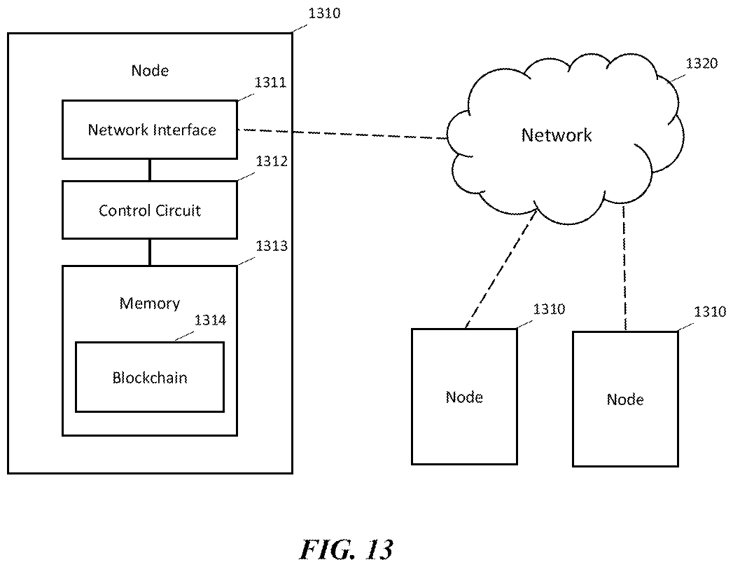

Now referring to FIG. 13, a system according to some embodiments is shown. A distributed blockchain system comprises a plurality of nodes 1310 communicating over a network 1320. In some embodiments, the nodes 1310 may comprise a distributed blockchain server and/or a distributed timestamp server. In some embodiments, one or more nodes 1310 may comprise or be similar to a “miner” device on the Bitcoin network. Each node 1310 in the system comprises a network interface 1311, a control circuit 1312, and a memory 1313.

The control circuit 1312 may comprise a processor, a microprocessor, and the like and may be configured to execute computer readable instructions stored on a computer readable storage memory 1313. The computer readable storage memory may comprise volatile and/or non-volatile memory and have stored upon it a set of computer readable instructions which, when executed by the control circuit 1312, causes the node 1310 to update the blockchain 1314 stored in the memory 1313 based on communications with other nodes 1310 over the network 1320. In some embodiments, the control circuit 1312 may further be configured to extend the blockchain 1314 by processing updates to form new blocks for the blockchain 1314. Generally, each node may store a version of the blockchain 1314, and together, may form a distributed database. In some embodiments, each node 1310 may be configured to perform one or more steps described with reference to FIGS. 10-11 herein.

The network interface 1311 may comprise one or more network devices configured to allow the control circuit to receive and transmit information via the network 1320. In some embodiments, the network interface 1311 may comprise one or more of a network adapter, a modem, a router, a data port, a transceiver, and the like. The network 1320 may comprise a communication network configured to allow one or more nodes 1310 to exchange data. In some embodiments, the network 1320 may comprise one or more of the Internet, a local area network, a private network, a virtual private network, a home network, a wired network, a wireless network, and the like. In some embodiments, the system does not include a central server and/or a trusted third-party system. Each node in the system may enter and leave the network at any time.

With the system and processes shown in, once a block is formed, the block cannot be changed without redoing the work to satisfy census rules thereby securing the block from tampering. A malicious attacker would need to provide a proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain-backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one or more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain-based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain-based system allows content use, content exchange, and the use of the content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In one embodiment, a system for product source tracing comprises a network interface configured to communicate with a plurality of nodes of a supply chain distributed ledger corresponding to a plurality of entities in a supply chain, a user interface device, and a control circuit coupled to the network interface and the user interface device. The control circuit being configured to communicate, via the network interface, with the plurality of nodes of the supply chain distributed ledger as a node of the supply chain distributed ledger, the supply chain distributed ledger comprising a plurality of product lot records associated with a plurality of products, wherein each product lot record comprises a series of supply chain events and each supply chain event is associated with a supply chain entity and a date, receive a product source query comprising an item descriptor and a plurality of case records, wherein each case record comprises a case location identifier and a case date associated with a product safety issue, query the supply chain distributed ledger and match each case report to at least one product lot record in the supply chain distributed ledger based on the item descriptor, the case location identifier, and the case date recorded in the case report, assign a weighting factor to each matched lot record matched with a case in the product source query based on a completeness of the matched lot record, determine a supplier confidence score for a supplier based on the number of matched lot records associated with the supplier and weighting factors associated with each matched lot record associated with the supplier, and automatically generate a product safety tracing report for display via the user interface device, the product safety tracing report comprises a ranked list of suppliers associated with the product safety issue based on supplier confidence scores of a plurality of suppliers.

In one embodiment, a method for product source tracing, the method comprises communicating, via a network interface, with a plurality of nodes of a supply chain distributed ledger as a node of the supply chain distributed ledger, the supply chain distributed ledger comprising a plurality of product lot records associated with a plurality of products, wherein each product lot record comprises a series of supply chain events and each supply chain event is associated with a supply chain entity and a date, receiving, at a control circuit, a product source query comprising an item descriptor and a plurality of case records, wherein each case record comprises a case location identifier and a case date associated with a product safety issue, querying, with the control circuit, the supply chain distributed ledger and matching each case report to at least one product lot record in the supply chain distributed ledger based on the item descriptor, the case location identifier, and the case date recorded in the case report, assigning, with the control circuit, a weighting factor to each matched lot record matched with a case in the product source query based on a completeness of the matched lot record, determining, with the control circuit, a supplier confidence score for a supplier based on the number of matched lot records associated with the supplier and weighting factors associated with each matched lot record associated with the supplier, and automatically generating, with the control circuit, a product safety tracing report for display via the user interface device, the product safety tracing report comprises a ranked list of suppliers associated with the product safety issue based on supplier confidence scores of a plurality of suppliers.

In one embodiment, an apparatus product source comprises a non-transitory storage medium storing a set of computer readable instructions and a control circuit configured to execute the set of computer readable instructions which cause to the control circuit to communicate, via a network interface, with a plurality of nodes of a supply chain distributed ledger as a node of the supply chain distributed ledger, the supply chain distributed ledger comprising a plurality of product lot records associated with a plurality of products, wherein each product lot record comprises a series of supply chain events and each supply chain event is associated with a supply chain entity and a date, receive a product source query comprising an item descriptor and a plurality of case records, wherein each case record comprises a case location identifier and a case date associated with a product safety issue, query the supply chain distributed ledger and match each case report to at least one product lot record in the supply chain distributed ledger based on the item descriptor, the case location identifier, and the case date recorded in the case report, assign a weighting factor to each matched lot record matched with a case in the product source query based on a completeness of the matched lot record, determine a supplier confidence score for a supplier based on the number of matched lot records associated with the supplier and weighting factors associated with each matched lot record associated with the supplier, and automatically generate a product safety tracing report for display via a user interface device, the product safety tracing report comprises a ranked list of suppliers associated with the product safety issue based on supplier confidence scores of a plurality of suppliers.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for product source tracing, the system comprises:
a network interface configured to communicate with a plurality of nodes of a supply chain distributed ledger corresponding to a plurality of entities in a supply chain;
a user interface device; and
a control circuit coupled to the network interface and the user interface device, the control circuit being configured to:
communicate, via the network interface, with the plurality of nodes of the supply chain distributed ledger as a node of the supply chain distributed ledger, the supply chain distributed ledger comprising a plurality of product lot records associated with a plurality of products, wherein each product lot record comprises a series of supply chain events and each supply chain event is associated with a supply chain entity and a date;
receive a product source query comprising an item descriptor and a plurality of case records, wherein each case record comprises a case location identifier and a case date associated with a product safety issue;
query the supply chain distributed ledger and match each case report to at least one product lot record in the supply chain distributed ledger based on the item descriptor, the case location identifier, and the case date recorded in the case report;
assign a weighting factor to each matched lot record matched with a case in the product source query based on a completeness of the matched lot record;
determine a supplier confidence score for a supplier based on the number of matched lot records associated with the supplier and weighting factors associated with each matched lot record associated with the supplier; and
automatically generate a product safety tracing report for display via the user interface device, the product safety tracing report comprises a ranked list of suppliers associated with the product safety issue based on supplier confidence scores of a plurality of suppliers.

2. The system of claim 1, wherein the supplier confidence score is further determined based on dividing a supplier weightage of all case records associated with the product safety issue for a supplier by a sum a total weightage for all suppliers associated with product lot records matched to cases associated with the product safety issue.

3. The system of claim 2, where a supplier weightage for a case record is determined based on adding a first value calculated based on multiplying the number of matched product lot records associated with the supplier having an incomplete record with a first weightage and a second value calculated based on multiplying the number of matched product lot records associated with the supplier having a complete record with a second weightage greater than the first weightage.

4. The system of claim 3, where the supplier weightage for each case record is further determined based on adding a third value calculated based on multiplying a case weightage with a trace weightage, wherein the trace weightage is less than one if a least one matched lot record associated with the supplier for the case is incomplete.

5. The system of claim 2, wherein the total weightage for all suppliers associated with the product lot records matched to the cases associated with the product safety issue is determined based on adding the number of case records multiplied by a case weightage and a count of supplier occurrences in all cases multiplied by a supplier weightage.

6. The system of claim 1, wherein the supplier confidence score is further determined based on a supplier volume weighting factor associated with a percentage of total store location inventory provided by the supplier.

7. The system of claim 1, wherein the control circuit is further configured to determine a lot confidence score for a product lot based on the number of matched lot records associated with cases of the product safety issue and weighting factors associated with each matched lot record associated with the cases, wherein the product safety tracing report further comprises a ranked list of lots associated with the product safety issue based on lot confidence scores for a plurality of lots.

8. The system of claim 1, wherein the completeness of a matched lot record is determined based on a supply chain entity associated with a last supply chain event in the matched lot record.

9. The system of claim 1, wherein a product lot record comprises at least a first supply chain event associated with a lot supplier and a second supply chain event associated with a distribution center.

10. The system of claim 1, wherein each supply chain event in a product lot record is updated by a supply chain entity associated with the supply chain event.

11. A method for product source tracing, the method comprises:
communicating, via a network interface, with a plurality of nodes of a supply chain distributed ledger as a node of the supply chain distributed ledger, the supply chain distributed ledger comprising a plurality of product lot records associated with a plurality of products, wherein each product lot record comprises a series of supply chain events and each supply chain event is associated with a supply chain entity and a date;
receiving, at a control circuit, a product source query comprising an item descriptor and a plurality of case records, wherein each case record comprises a case location identifier and a case date associated with a product safety issue;
querying, with the control circuit, the supply chain distributed ledger and matching each case report to at least one product lot record in the supply chain distributed ledger based on the item descriptor, the case location identifier, and the case date recorded in the case report;
assigning, with the control circuit, a weighting factor to each matched lot record matched with a case in the product source query based on a completeness of the matched lot record;
determining, with the control circuit, a supplier confidence score for a supplier based on the number of matched lot records associated with the supplier and weighting factors associated with each matched lot record associated with the supplier; and
automatically generating, with the control circuit, a product safety tracing report for display via a user interface device, the product safety tracing report comprises a ranked list of suppliers associated with the product safety issue based on supplier confidence scores of a plurality of suppliers.

12. The method of claim 11, wherein the supplier confidence score is further determined based on dividing a supplier weightage of all case records associated with the product safety issue for a supplier by a sum a total weightage for all suppliers associated with product lot records matched to cases associated with the product safety issue.

13. The method of claim 12, where a supplier weightage for a case record is determined based on adding a first value calculated based on multiplying the number of matched product lot records associated with the supplier having an incomplete record with a first weightage and a second value calculated based on multiplying the number of matched product lot records associated with the supplier having a complete record with a second weightage greater than the first weightage.

14. The method of claim 13, where the supplier weightage for each case record is further determined based on adding a third value calculated based on multiplying a case weightage with a trace weightage, wherein the trace weightage is less than one if a least one matched lot record associated with the supplier for the case is incomplete.

15. The method of claim 12, wherein the total weightage for all suppliers associated with the product lot records matched to the cases associated with the product safety issue is determined based on adding the number of case records multiplied by a case weightage and a count of supplier occurrences in all cases multiplied by a supplier weightage.

16. The method of claim 11, wherein the supplier confidence score is further determined based on a supplier volume weighting factor associated with a percentage of total store location inventory provided by the supplier.

17. The method of claim 11, wherein the control circuit is further configured to determine a lot confidence score for a product lot based on the number of matched lot records associated with cases of the product safety issue and weighting factors associated with each matched lot record associated with the cases, wherein the product safety tracing report further comprises a ranked list of lots associated with the product safety issue based on lot confidence scores for a plurality of lots.

18. The method of claim 11, wherein the completeness of a matched lot record is determined based on a supply chain entity associated with a last supply chain event in the matched lot record.

19. The method of claim 11, wherein a product lot record comprises at least a first chain supply event associated with a lot supplier and a second supply chain event associated with a distribution center.

20. An apparatus product source comprising:
a non-transitory storage medium storing a set of computer-readable instructions; and
a control circuit configured to execute the set of computer-readable instructions which cause the control circuit to:
communicate, via a network interface, with a plurality of nodes of a supply chain distributed ledger as a node of the supply chain distributed ledger, the supply chain distributed ledger comprising a plurality of product lot records associated with a plurality of products, wherein each product lot record comprises a series of supply chain events and each supply chain event is associated with a supply chain entity and a date;
receive a product source query comprising an item descriptor and a plurality of case records, wherein each case record comprises a case location identifier and a case date associated with a product safety issue;
query the supply chain distributed ledger and match each case report to at least one product lot record in the supply chain distributed ledger based on the item descriptor, the case location identifier, and the case date recorded in the case report;
assign a weighting factor to each matched lot record matched with a case in the product source query based on a completeness of the matched lot record;
determine a supplier confidence score for a supplier based on the number of matched lot records associated with the supplier and weighting factors associated with each matched lot record associated with the supplier; and
automatically generate a product safety tracing report for display via a user interface device, the product safety tracing report comprises a ranked list of suppliers associated with the product safety issue based on supplier confidence scores of a plurality of suppliers.
